(19) United States
(12) Patent Application Publication
(10) Pub. No.: US 2023/0142914 A1
(43) Pub. Date: May 11, 2023

(54) NECK ASSEMBLY AND USES THEREOF

(71) Applicant: LOUGHBOROUGH UNIVERSITY, Leicestershire (GB)

(72) Inventors: Jon FARMER, Leicestershire (GB); Sean MITCHELL, Leicestershire (GB); Paul SHERRATT, Leicestershire (GB)

(21) Appl. No.: 17/916,149

(22) PCT Filed: Mar. 16, 2021
(86) PCT No.: PCT/GB2021/050654

§ 371 Date: Sep. 30, 2022

(30) Foreign Application Priority Data
Mar. 30, 2020 (GB) 2004653.8

(51) Int. Cl. G09B 23/32

(52) U.S. Cl. CPC G09B 23/32

(57) ABSTRACT

A neck assembly for use in an anthropomorphic test device comprising: a first mount disposed at a first end of the neck assembly, the first mount being adapted to be connected to a support structure; a second mount disposed at a second end of the neck assembly, the second mount being adapted to be connected to a test structure such as a surrogate head; and at least one movable joint disposed between the first mount and the second mount, the at least one movable joint being operable to rotate about at least three axes.

The present disclosure relates to a neck assembly for use in an anthropomorphic test device (ATD). This disclosure relates to a surrogate head for use in an anthropomorphic test device, e.g. in combination with a neck assembly disclosed herein. This disclosure also relates to uses of such a neck assembly and/or such a surrogate head, including for example in the testing and/or design of safety equipment, e.g. safety equipment for use in a sport or occupation.

An anthropomorphic test device (ATD) typically may be considered to comprise an entire surrogate (e.g. a full body). Typically, an ATD includes a surrogate torso and a surrogate head, the surrogate head being joined to the surrogate torso by a surrogate neck.

It is known to use anthropomorphic test devices in the crash testing of vehicles. An anthropomorphic test device used in the crash testing of vehicles may be known as a crash test dummy. Typically, the crash test dummy will be seated within a vehicle and the vehicle will then be subjected to one of a number of crash/impact scenarios. One commonly used test comprises a head-on impact involving a vehicle against a rigid barrier at 50 km/h.

A crash test dummy typically comprises a surrogate neck structure (i.e. a neck assembly) configured such that during testing the crash test dummy is positioned with a surrogate head facing forward. The surrogate neck structures employed in crash test dummies are particularly suitable for the purpose of investigating the effects of a single, high-speed collision, which predominantly provokes motion in a single anatomical plane. Furthermore, these surrogate necks can generally represent only a passive braced musculature state. As such, known surrogate neck structures typically comprise very stiff arrangements and are validated for motion in a single anatomical plane.

An example of a known surrogate neck structure for use in an anthropomorphic test device such as a crash test dummy is the Hybrid III, which was developed by Foster et al. [1], on behalf of General Motors (GM), and is currently manufactured by companies such as Humanetics and Cellbond, amongst others.

The Hybrid III surrogate neck has been used in testing applications other than vehicle crash testing, for instance in the testing of safety helmets for sports. However, the impacts experienced while playing a sport or other occupation differ, e.g. in terms of level of muscle activation and the force vector experienced, compared with a single, large collision. Furthermore, the stance and neck orientation of a participant in a sport or other occupation prior to an impact or series of impacts will typically not be the same as if s/he were sat in the driver's or passenger's seat of a car. Thus, the Hybrid III surrogate neck may not in fact be appropriate for testing in some applications, e.g. testing safety equipment for use in a sport or occupation, since it may not exhibit behaviour similar to that of a human neck, i.e. it may be considered to have low biofidelity, in these scenarios. Consequently, for example, safety standards to which safety equipment must comply may be drawn up based on research carried out using surrogate structures (e.g. surrogate necks) that do not adequately represent the expected, actual human response. This may lead, ultimately, for example, to safety equipment being designed and produced that is poorly adapted to protect a participant from likely impacts experienced in a given sport or occupation. Such safety equipment could include, for example, cricket helmets or riot helmets for policemen. Such safety equipment may be termed personal protective equipment (PPE).

Similarly, the Hybrid III surrogate neck may not be well suited for use in the study of potential injury risks for the participants in a given sport or occupation, especially given its inability to represent those who may be unaware and unbraced prior to an impact.

More recently, surrogate necks such as that described in U.S. Pat. No. 9,972,220B2, have addressed some of the inadequacies of the Hybrid III. Specifically, U.S. Pat. No. 9,972,220B2 discloses a surrogate neck that uses a plurality of vertebra to provide flexion/extension and lateral flexion responses, i.e. motion about two anatomical planes. However, it does not readily lend itself to adjustable stiffness properties, nor does it provide an axial rotation response with range of motion (ROM) equivalent to the human neck.

Further, a successor to the Hybrid III, named the Thor-M surrogate neck, was commissioned by the National Highway Traffic Safety Administration, to provide a passive unbraced and passive braced response in each of the anatomical planes. However, the Thor-M has been shown to be overly stiff when compared to the human neck in a passive unbraced state [2]. In particular, the Thor-M surrogate neck is not capable of representing the neutral zone (NZ) axial rotation response, i.e. a region where approximately 50% of the total range of motion can be achieved with negligible torque application. In addition, the response of the surrogate neck in axial rotation was identical between its two embodiments (i.e. with and without the muscle cables), presenting a further limitation to its construction.

A further shortcoming of many prior art surrogate necks such as those discussed above is that they typically do not adequately model the level of cervical lordosis of the human neck. Typically, the neutral posture of these prior art surrogate necks is only nominally adjustable with respect to the torso. For example, the Hybrid III contains a bracket adjustment which permits a forward and backward rotation of 7° of the neck beam relative to the torso.

Another example of a known surrogate neck is disclosed in EP3392638A1.

Another example of a known surrogate neck is disclosed in U.S. Pat. No. 5,152,692.

A first aspect provides a neck assembly (a surrogate neck) for use in an anthropomorphic test device comprising:
a first mount disposed at a first end of the neck assembly, the first mount being adapted to be connected to a support structure;
a second mount disposed at a second end of the neck assembly, the second mount being adapted to be connected to a test structure such as a surrogate head; and
at least one movable joint disposed between the first mount and the second mount, the at least one movable joint being operable to rotate about at least three axes.

The three axes may be mutually perpendicular, i.e. the three axes may be orthogonal axes.

Advantageously, the at least one movable joint operable to rotate about at least three axes may provide the neck assembly with a range of motion that is representative of that achievable by a typical human neck in each of the anatomical planes (i.e. the coronal plane, the sagittal plane and the transverse plane).

One or more of the movable joints may comprise a ball joint.

The first mount may be suitable to form a connection with any suitable support structure such as a surrogate torso.

The first mount may comprise a first mount portion and a second mount portion, wherein the second mount portion is adjustably fixable relative to the first mount portion in a plurality of orientations, to represent, in use, different initial orientations (postures).

The second mount may be adjustable to form, in use, a connection with one or more different test structures, e.g. surrogate heads. The second mount may comprise a connection means adjustable in the X and/or Y directions relative to a connection surface of the second mount. As such, the centre of gravity of a connected test structure, e.g. surrogate head, may be moved in relation to the neck assembly.

Advantageously, providing a means for connecting to a plurality of different surrogate heads may allow for a number of surrogate heads from different manufacturers to be used with the neck assembly.

Advantageously, providing an adjustable connection means may allow for a number of surrogate heads comprising a different centre of mass/centre of gravity to be used with the neck assembly.

One or more of the ball joints may comprise at least one socket portion and a bearing. One or more of the ball joints may comprise at least two socket portions. At least one socket portion may partially encapsulate the bearing such that the bearing may be removed from the socket. At least one socket portion may partially encapsulate a bearing such that the bearing remains secured within the socket. At least one ball joint may comprise two socket portions configured to at least partially encapsulate one bearing.

Each ball joint present may comprise the same, or a different, range of motion to any other ball joint present. Each ball joint may comprise sockets and/or bearings comprising different geometries such that each ball joint present provides a different range of motion.

The neck assembly may comprise at least two ball joints. The neck assembly may comprise three ball joints. Each of the ball joints may be arranged between the first mount and the second mount. Each ball joint may provide the same, or different, ranges of motion. The ball joints may be configured to simulate typical ranges of motion possible by a human neck. For example, three ball joints may be spaced apart and arranged to approximately simulate the C0/C1, C3/C4 and C7/T1 vertebral levels within a human neck.

The locations of the joint(s) may be determined with reference to a model based on the anatomy of the human cervical spine. For instance, using a model with matched human geometry (e.g. lordosis conforming to Harrison's Elliptical Model), intervertebral range of motion and normalised instantaneous centres of rotations, it is possible to predict the motion path of the human neck and therefore show the end location and orientation of the human head during flexion/extension and lateral flexion. The range of motion and placement of the ball joints may allow for a surrogate head connected to the second mount of the neck assembly to accurately match these locations and orientations, in use, using just three joints, whereas in the human cervical spine, there are eight joints.

The ball joints may be positioned to provide the appropriate range and distribution of the typical human range of motion in each of the anatomical planes.

Each ball joint may comprise a bearing and a socket for receiving the bearing. Each bearing and socket present may comprise any suitable material. Each bearing and socket present may comprise a metal, a metal compound, an alloy, or the like. At least one socket may comprise stainless steel. At least one bearing may comprise phosphor bronze. At least one bearing and/or socket portion may comprise a polymer.

Each ball joint present may be spaced apart by one or more members. The one or more members may be fixedly connected to one or more ball joints, and may be fixedly connected to a bearing and/or a socket portion. The one or more members may be configured to allow movement within the neck assembly in addition to the range of movement provided by the ball joints. The one or more members may comprise rigid members. At least one member may comprise a wedge shape. At least one member may comprise a disc shape.

The neck assembly may comprise at least one resilient member arranged to extend across at least a portion of the at least one movable joint.

The at least one resilient member may provide a means for applying a force on the neck assembly that is representative of the forces applied by the ligamentous structures of the human neck and/or by the passive unbraced neck musculature.

The neck assembly may comprise at least one pair of resilient, e.g. elastic, members arranged on opposing sides of at least one of the joints, e.g. ball joints. At least one pair of elastic members may be arranged on the lateral sides of the neck assembly. At least one pair of elastic members may be arranged on the front and back sides of the neck assembly. At least one pair of elastic members may be arranged to extend from one side of a substantially horizontal plane comprising the centre of rotation of a ball joint to an opposing side of the plane.

At least one pair of resilient members may be connected to members disposed either side of a plane comprising the centre of rotation of a ball joint such that the elastic members extend across a substantial portion of the ball joint. In this way, the elastic members may be arranged to provide opposing forces upon the ball joint such that the ball joint is resiliently biased to a neutral position wherein a net force of 0 N is acting upon the ball joint. Two or more ball joints may be arranged similarly.

The neck assembly may comprise at least two pairs of opposing resilient members arranged to extend across at least one ball joint. A first pair of elastic members may be arranged at opposing lateral sides of a ball joint and a second pair of elastic members may be arranged at the front and back sides of the same ball joint. In this way, the two pairs of elastic members may resiliently bias the ball joint to a position wherein a net force of 0N is acting upon the ball joint. Two or more ball joints may be arranged similarly.

A first pair of elastic members may comprise different elastic properties from a second pair of elastic members arranged to act upon the same ball joint. Such differences in properties may represent different magnitudes of forces produced by ligaments and/or muscles in the neck through a range of different movements.

The at least one resilient member may comprise a polymeric material. The at least one elastic member may comprise any suitable polymeric material operable to extend elastically. The at least one elastic member may comprise a rubber. Each resilient member may comprise substantially the same material, or at least one resilient member may comprise a different material from another resilient member.

Each resilient member may have the same, or different, lengths. Each opposing pair of resilient members may comprise the same, or different, lengths. Resilient members of different lengths may be connected to the neck assembly to achieve different neutral positions where the forces produced by the resilient members are balanced.

Advantageously, for example, resilient members comprising different lengths may allow the neck assembly to simulate a non-anatomical, non-neutral or braced position prior to being subjected to an external force. An orientation of the neck assembly that does not simulate passive unbraced position may be achieved by using resilient members of different lengths or different elastic properties.

At least one of the resilient members may form one or more detachable connections with the neck assembly. Each resilient member may form a detachable connection with the neck assembly.

Advantageously, detachable resilient members may allow for said elastic members to be easily changed. Changing the resilient members may allow for the neck assembly to easily simulate multiple human necks comprising ligaments and/or muscles of varying strengths.

The neck assembly may comprise at least one movable joint that does not comprise a ball joint. The joint may comprise a rotary joint. The rotary joint may be configured to rotate between two pre-determined end points.

The neck assembly may comprise a rotary joint disposed at a location between the first end and the second end of the neck assembly, the rotary joint being arranged to provide axial rotation about a single axis of rotation within the neck assembly, the single axis of rotation extending in a locally lengthwise direction.

The neck assembly may comprise at least one movable joint (e.g. the or a rotary joint) that is not acted upon by a resilient member. The movable joint that is not acted upon by a resilient member may comprise the at least one movable joint that does not comprise a ball joint. The neck assembly may comprise one movable joint that is not acted upon by one or more resilient members, e.g. elastic members.

The at least one movable joint, e.g. the rotary joint, that is not acted upon by any resilient members may be configured to simulate the typical range of motion through the neutral zone of a human neck. The at least one movable joint that is not acted upon by any resilient members may be operable to provide a range of motion with negligible torque application. The at least one movable joint that is not acted upon by any resilient members may represent the neutral zone (NZ) axial rotation response of a human neck. The range of motion with negligible torque application may comprise approximately 50% of the total axial rotation range of motion.

Advantageously, a neck assembly comprising a joint operable to simulate the neutral zone movement of a human neck may provide a neck assembly that more accurately and/or realistically represents the response of a human neck when subjected to an external force.

The neck assembly may comprise at least one release member arranged to extend across at least a portion of one of the ball joints. The release member may be configured to bias temporarily the neck assembly towards a pre-determined position (posture). The release member may be configured to at least partially detach from the neck assembly upon application of a predetermined threshold force, e.g. a threshold torsional force.

A second aspect provides a neck assembly (a surrogate neck) for use in an anthropomorphic test device comprising:
a first mount disposed at a first end of the neck assembly, the first mount being adapted to be connected to a support structure;
a second mount disposed at a second end of the neck assembly, the second mount being adapted to be connected to a test structure such as a surrogate head;
a rigid elongate member extending between the first mount and the second mount, wherein a first end of the rigid elongate member is connected to the first mount by a first pivot joint and a second end of the rigid elongate member is connected to the second mount by a second pivot joint;
wherein the first pivot joint is configured to allow pivotal motion of the rigid elongate member relative to the first mount and the second pivot joint is configured to allow pivotal motion of the rigid elongate member relative to the second mount within a single plane of rotation about two discrete axes of rotation.

The plane of rotation may comprise a sagittal plane. Alternatively, the plane of rotation may comprise a coronal (frontal) plane.

The first pivot joint and/or the second pivot joint may be configured to allow relatively unrestricted rotation about their respective axes of rotation.

The neck assembly may comprise one or more stop means to limit rotation allowed by the first pivot joint and/or the second pivot joint.

The neck assembly may be configured to provide an overall range of motion in the plane of rotation, wherein the overall range of motion is distributed across the first pivot joint and the second pivot joint such that the overall range of motion equals the sum of the maximum rotational movements allowed by the first and second pivot joints. The overall range of motion in the plane of rotation may be at least 60° and/or up to 180°. The overall range of motion in the plane of rotation may be up to or at least 90°. The overall range of motion may be up to or at least 120°.

The neck assembly may be configured such that the maximum range of rotational movement allowed by the first joint is greater than the maximum range of rotational movement allowed by the second joint. For example, the maximum range of rotational movement allowed by the first joint may be twice the maximum range of rotational movement allowed by the second joint.

The neck assembly may be configured such that the maximum range of rotational movement allowed by the first joint is less than the maximum range of rotational movement allowed by the second joint.

The neck assembly may be configured such that the maximum range of rotational movement allowed by the first joint is the same as the maximum range of rotational movement allowed by the second joint.

The second mount may be adjustable to form, in use, a connection with one or more different test structures, e.g. surrogate heads. The second mount may comprise a connection means adjustable in the X and/or Y directions relative to a connection surface of the second mount. As such, the centre of gravity of a connected test structure, e.g. surrogate head, may be moved in relation to the neck assembly.

Advantageously, providing a means for connecting to a plurality of different surrogate heads may allow for a number of surrogate heads from different manufacturers to be used with the neck assembly.

Advantageously, providing an adjustable connection means may allow for a number of surrogate heads comprising a different centre of mass/centre of gravity to be used with the neck assembly.

The neck assembly may comprise a rotary joint disposed at a location between the first end and the second end of the neck assembly, the rotary joint being arranged to provide axial rotation about a single axis of rotation within the neck assembly, the single axis of rotation extending in a locally lengthwise direction.

The neck assembly may comprise a rotary joint disposed between the first mount and the second mount configured such that, in use, a connected test structure is able to rotate about a transverse or longitudinal axis with zero or negligible resistance to rotation. The rotary joint may be disposed near to the second mount.

The rotary joint may be configured to provide a range of motion with negligible torque application. The rotary joint may represent the neutral zone (NZ) axial rotation response of a human neck. The range of motion with negligible torque application may comprise approximately 50% of the total axial rotation range of motion.

Advantageously, the neck assembly may be operable to simulate axial rotation typically experienced by a human neck during lateral flexion. Axial rotation is experienced by a human neck when lateral flexion is induced by a lateral impact force applied anteriorly or posteriorly to the head's centre of gravity.

The neck assembly may comprise at least one resilient member arranged to extend across at least a portion of the first pivot joint. The neck assembly may comprise at least one resilient member arranged to extend across at least a portion of the second pivot joint. The at least one resilient member may be configured to resiliently bias the neck assembly towards a pre-determined position.

The neck assembly may comprise at least one release member arranged to extend across at least a portion of the first pivot and/or second pivot. The release member may be configured to bias temporarily the neck assembly towards a pre-determined position (posture). The release member may be configured to at least partially detach from the neck assembly upon application of a predetermined threshold force, e.g. a threshold torsional force.

The first mount may comprise a first mount portion and a second mount portion, wherein the second mount portion is adjustably fixable relative to the first mount portion in a plurality of orientations, to represent, in use, different initial orientations (postures).

The rigid elongate member may be termed a neck beam.

A third aspect provides a neck assembly (a surrogate neck) for use in an anthropomorphic test device comprising:
a first mount disposed at a first end of the neck assembly, the first mount being adapted to be connected to a support structure;
a second mount disposed at a second end of the neck assembly, the second mount being adapted to be connected to a test structure such as a surrogate head; and
a rotary joint disposed at a location between the first end and the second end of the neck assembly, the rotary joint being arranged to provide axial rotation about a single axis of rotation within the neck assembly, the single axis of rotation extending in a locally lengthwise direction.

The rotary joint may be disposed near to or adjacent the second mount.

The rotary joint may be disposed between the first mount and the second mount.

The rotary joint may comprise a plain bearing.

The rotary joint may be configured such that, in use, the test structure can rotate with zero or negligible resistance to rotation.

The rotary joint may be positioned and arranged to provide a realistic neutral zone for axial rotation at the C1-C2 joint region of the human cervical spine

The rotary joint may provide a range of motion with negligible torque application. The rotary joint may represent the neutral zone (NZ) axial rotation response of a human neck. The range of motion with negligible torque application may comprise approximately 50% of the total axial rotation range of motion.

The second mount may be adjustable to form, in use, a connection with one or more different test structures, e.g. surrogate heads. The second mount may comprise a connection means adjustable in the X and/or Y directions relative to a connection surface of the second mount. As such, the centre of gravity of a connected test structure, e.g. surrogate head, may be moved in relation to the neck assembly.

Advantageously, providing a means for connecting to a plurality of different surrogate heads may allow for a number of surrogate heads from different manufacturers to be used with the neck assembly.

Advantageously, providing an adjustable connection means may allow for a number of surrogate heads comprising a different centre of mass/centre of gravity to be used with the neck assembly.

The neck assembly may comprise:
a rigid elongate member extending between the first mount and the second mount, wherein a first end of the rigid elongate member is connected to the first mount by a first pivot joint and a second end of the rigid elongate member is connected to the second mount by a second pivot joint;
wherein the first pivot joint is configured to allow pivotal motion of the rigid elongate member relative to the first mount and the second pivot joint is configured to allow pivotal motion of the rigid elongate member relative to the second mount within a single plane of rotation about two discrete axes of rotation.

The rotary joint may be disposed between the second pivot joint and the second mount.

The plane of rotation may comprise a sagittal plane. Alternatively, the plane of rotation may comprise a coronal (frontal) plane.

The first pivot joint and/or the second pivot joint may be configured to allow relatively unrestricted rotation about their respective axes of rotation.

The neck assembly may comprise one or more stop means to limit rotation allowed by the first pivot joint and/or the second pivot joint.

The neck assembly may be configured to provide an overall range of motion in the plane of rotation, wherein the overall range of motion is distributed across the first pivot joint and the second pivot joint such that the overall range of motion equals the sum of the maximum rotational movements allowed by the first and second pivot joints. The overall range of motion in the plane of rotation may be at least 60° and/or up to 180°. The overall range of motion in the plane of rotation may be up to or at least 90°. The overall range of motion in the plane of rotation may be up to or at least 120°.

The neck assembly may be configured such that the maximum range of rotational movement allowed by the first joint is greater than the maximum range of rotational movement allowed by the second joint. For example, the maximum range of rotational movement allowed by the first joint may be twice the maximum range of rotational movement allowed by the second joint.

The neck assembly may be configured such that the maximum range of rotational movement allowed by the first joint is less than the maximum range of rotational movement allowed by the second joint.

The neck assembly may be configured such that the maximum range of rotational movement allowed by the first joint is the same as the maximum range of rotational movement allowed by the second joint.

The neck assembly may comprise at least one movable joint disposed between the first mount and the second mount, the at least one movable joint being operable to rotate about at least three axes.

The three axes may be mutually perpendicular, i.e. the three axes may be orthogonal axes.

Advantageously, the at least one movable joint operable to rotate about at least three axes may provide the neck assembly with a range of motion that is representative of that achievable by a typical human neck in each of the anatomical planes (i.e. the coronal plane, the sagittal plane and the transverse plane).

The at least one movable joint being operable to rotate about at least three axes may comprise a ball joint. One or more of the ball joints may comprise at least one socket portion and a bearing. One or more of the ball joints may comprise at least two socket portions. At least one socket portion may partially encapsulate the bearing such that the bearing may be removed from the socket. At least one socket portion may partially encapsulate a bearing such that the bearing remains secured within the socket. At least one ball joint may comprise two socket portions configured to at least partially encapsulate one bearing.

Each ball joint present may comprise the same, or a different, range of motion to any other ball joint present. Each ball joint may comprise sockets and/or bearings comprising different geometries such that each ball joint present provides a different range of motion.

The neck assembly may comprise at least two ball joints. The neck assembly may comprise three ball joints. Each of the ball joints may be arranged between the first mount and the second mount. Each ball joint may provide the same, or different, ranges of motion. The ball joints may be configured to simulate typical ranges of motion possible by a human neck. For example, three ball joints may be spaced apart and arranged to approximately simulate the C0/C1, C3/C4 and C7/T1 vertebral levels within a human neck.

The locations of the joint(s) may be determined with reference to a model based on the anatomy of the human cervical spine. For instance, using a model with matched human geometry (e.g. lordosis conforming to Harrison's Elliptical Model), intervertebral range of motion and normalised instantaneous centres of rotations, it is possible to predict the motion path of the human neck and therefore show the end location and orientation of the human head during flexion/extension and lateral flexion. The range of motion and placement of the ball joints may allow for a surrogate head connected to the second mount of the neck assembly to accurately match these locations and orientations, in use, using just three joints, whereas in the human cervical spine, there are eight joints.

The ball joints may be positioned to provide the appropriate range and distribution of the typical human range of motion in each of the anatomical planes.

Each ball joint may comprise a bearing and a socket for receiving the bearing. Each bearing and socket present may comprise any suitable material. Each bearing and socket present may comprise a metal, a metal compound, an alloy, or the like. At least one socket may comprise stainless steel. At least one bearing may comprise phosphor bronze. At least one bearing and/or socket portion may comprise a polymer.

Each ball joint present may be spaced apart by one or more members. The one or more members may be fixedly connected to one or more ball joints, and may be fixedly connected to a bearing and/or a socket portion. The one or more members may be configured to allow movement within the neck assembly in addition to the range of movement provided by the ball joints. The one or more members may comprise rigid members. At least one member may comprise a wedge shape. At least one member may comprise a disc shape.

The neck assembly may comprise at least one resilient member arranged to extend across at least a portion of at least one pivot or ball joint.

The at least one resilient member may provide a means for applying a force on the neck assembly that is representative of the forces applied by the ligamentous structures of the human neck and/or by the passive unbraced neck musculature.

The neck assembly may comprise at least one pair of resilient, e.g. elastic, members arranged on opposing sides of at least one of the joints, e.g. ball joints. At least one pair of elastic members may be arranged on the lateral sides of the neck assembly. At least one pair of elastic members may be arranged on the front and back sides of the neck assembly. At least one pair of elastic members may be arranged to extend from one side of a substantially horizontal plane comprising the centre of rotation of a ball joint to an opposing side of the plane.

At least one pair of resilient members may be connected to members disposed either side of a plane comprising the centre of rotation of a ball joint such that the elastic members extend across a substantial portion of the ball joint. In this way, the elastic members may be arranged to provide opposing forces upon the ball joint such that the ball joint is resiliently biased to a neutral position wherein a net force of 0 N is acting upon the ball joint. Two or more ball joints may be arranged similarly.

The neck assembly may comprise at least two pairs of opposing resilient members arranged to extend across at least one ball joint. A first pair of elastic members may be arranged at opposing lateral sides of a ball joint and a second pair of elastic members may be arranged at the front and back sides of the same ball joint. In this way, the two pairs of elastic members may resiliently bias the ball joint to a position wherein a net force of 0N is acting upon the ball joint. Two or more ball joints may be arranged similarly.

A first pair of elastic members may comprise different elastic properties from a second pair of elastic members arranged to act upon the same ball joint. Such differences in properties may represent different magnitudes of forces produced by ligaments and/or muscles in the neck through a range of different movements.

The at least one resilient member may comprise a polymeric material. The at least one elastic member may comprise any suitable polymeric material operable to extend elastically. The at least one elastic member may comprise a rubber. Each resilient member may comprise substantially the same material, or at least one resilient member may comprise a different material from another resilient member. Each resilient member may have the same, or different, lengths. Each opposing pair of resilient members may comprise the same, or different, lengths. Resilient members of different lengths may be connected to the neck assembly to achieve different neutral positions where the forces produced by the resilient members are balanced.

Advantageously, for example, resilient members comprising different lengths may allow the neck assembly to simulate a non-anatomical, non-neutral or braced position prior to being subjected to an external force. An orientation of the neck assembly that does not simulate passive unbraced position may be achieved by using resilient members of different lengths or different elastic properties.

At least one of the resilient members may form one or more detachable connections with the neck assembly. Each resilient member may form a detachable connection with the neck assembly.

Advantageously, detachable resilient members may allow for said elastic members to be easily changed. Changing the resilient members may allow for the neck assembly to easily simulate multiple human necks comprising ligaments and/or muscles of varying strengths.

The neck assembly may comprise at least one release member arranged to extend across at least a portion of one of the ball joints and/or one of the pivot joints. The release member may be configured to bias temporarily the neck assembly towards a pre-determined position (posture). The release member may be configured to at least partially detach from the neck assembly upon application of a predetermined threshold force, e.g. a threshold torsional force.

A fourth aspect provides an assembly comprising:
a neck assembly according to the first aspect or the second aspect or the third aspect; and
a test structure connected to the second mount.

The first mount may be connected to a support structure such as a surrogate torso.

The test structure may comprise a surrogate head.

The surrogate head may be transparent at least in part.

The surrogate head may comprise a surrogate skull and a surrogate brain contained therein, wherein the surrogate brain can move within the surrogate skull.

The surrogate head may comprise a sensor arranged to measure, in use, surrogate skull kinematics. The sensor may comprise a motion sensor such as a six-degree-of-freedom sensor. The sensor may be located in a nose region of the surrogate skull.

In example embodiments where the surrogate head is transparent at least in part, the surrogate head may comprise a marker pattern disposed on one or more surfaces of the surrogate brain and surrogate skull. The marker pattern may be disposed along a mid-sagittal plane of the surrogate brain and surrogate skull surfaces. The provision of such a marker pattern may facilitate measurement, in use, of brain kinematics, e.g. using high-speed video cameras.

Alternatively or additionally, the surrogate head may comprise one or more sensors, e.g. motion sensors, on or in the surrogate brain, the sensor(s) being arranged to measure, in use, surrogate brain kinematics.

In an example implementation, the surrogate brain may comprise a left hemisphere and a right hemisphere, a first motion sensor may be mounted on or in the left hemisphere and a second motion sensor may be mounted on or in the right hemisphere.

One or more of the motion sensors may include an accelerometer, e.g. a tri-axial accelerometer. One or more of motion sensors may include a gyroscope, e.g. a tri-axial gyroscope.

One or more of the motion sensors may include a six-degree-of-freedom (6DOF) sensor. The six-degree-of-freedom sensor may include a tri-axial accelerometer and a a tri-axial gyroscope.

The surrogate skull may comprise at least one motion sensor arranged to detect movement of the surrogate brain.

The motion sensor(s) may be operably connected to a data logger.

In one example implementation, a six-degree-of-freedom sensor (e.g. comprising a tri-axial accelerometer and a tri-axial gyroscope) may be embedded in each of the left and right hemispheres of the surrogate brain.

An assembly disclosed herein may be provided with a support structure arranged to support or hold, in use, a test structure such as a surrogate head connected to the neck assembly. The support structure may comprise a release mechanism operable to release the test structure. For instance, in use, the release mechanism may be operated immediately prior to the test structure being subjected to an impact. Accordingly, it may be possible to carry out, for example, tests on a surrogate head in a range of passive unbraced orientations, which may, for example, be useful in studying the effects of head impacts on unconscious or sleeping people.

A fifth aspect provides a use of a neck assembly according to a first aspect, a neck assembly according to the second aspect, a neck assembly according to the third aspect or an assembly according to the fourth aspect in testing a piece of safety equipment.

A sixth aspect provides a use of a neck assembly according to the first aspect, a neck assembly according to the second aspect, a neck assembly according to the third aspect or an assembly according to the fourth aspect in studying potential injury, e.g. brain injury.

The neck assembly and/or the assembly comprising a neck assembly and a test structure, e.g. a surrogate head, connected thereto may be suitable for use in studying traumatic brain injuries, which may include concussion.

Results of studies carried out using a neck assembly or an assembly comprising a neck assembly and a test structure, e.g. a surrogate head, connected thereto according to the present disclosure may be useful in devising improved designs of pieces of safety equipment, e.g. items of personal protective equipment. Such pieces of safety equipment may include, for example, helmets for a given use or activity.

Results of studies carried out using a neck assembly or an anthropomorphic test device according to the present disclosure may be useful in informing the development of improved safety regulations for particular activities.

Results of studies carried out using a neck assembly or an anthropomorphic test device according to the present disclosure may be useful in informing the development of improved specifications for the pieces of safety equipment, e.g. items of personal protective equipment. Such pieces of safety equipment may include, for example, helmets for a given use or activity.

Except where mutually exclusive, any of the features of the first aspect may be employed mutatis mutandis in any of the other aspects.

The invention will now be described by way of example only with reference to the accompanying drawings in which:

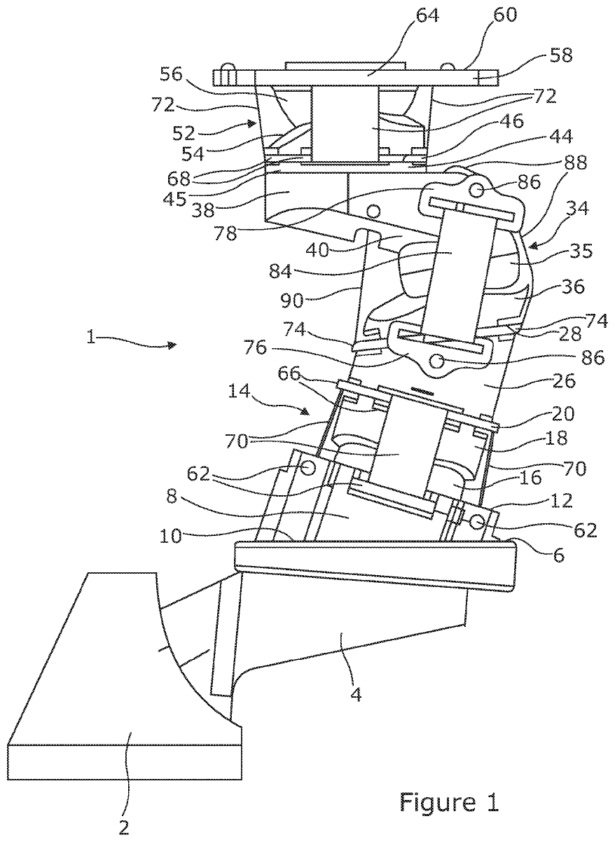

FIG. 1 shows an example of a neck assembly;

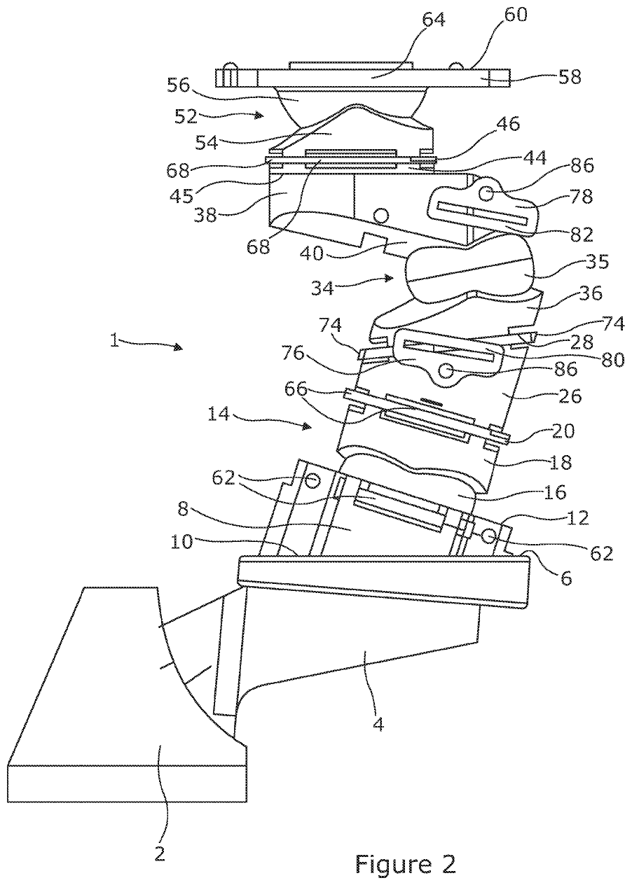

FIG. 2 shows the neck assembly of FIG. 1 with the elastic members removed;

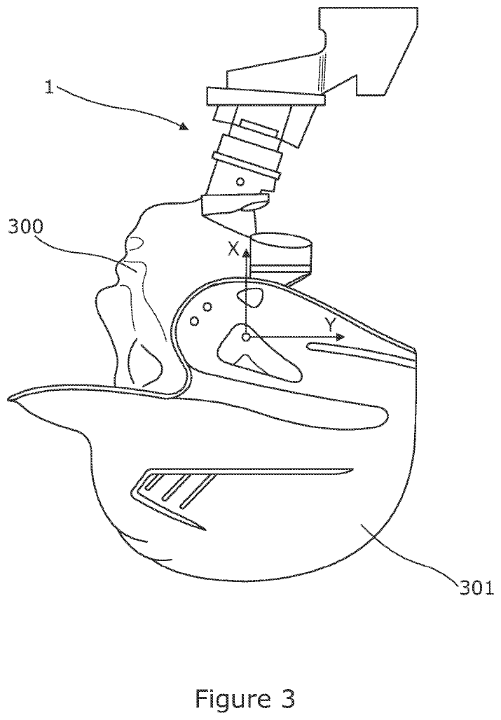

FIG. 3 shows the neck assembly of FIG. 1 and FIG. 2 with a surrogate head attached thereto, the surrogate head having a baseball batting helmet thereon;

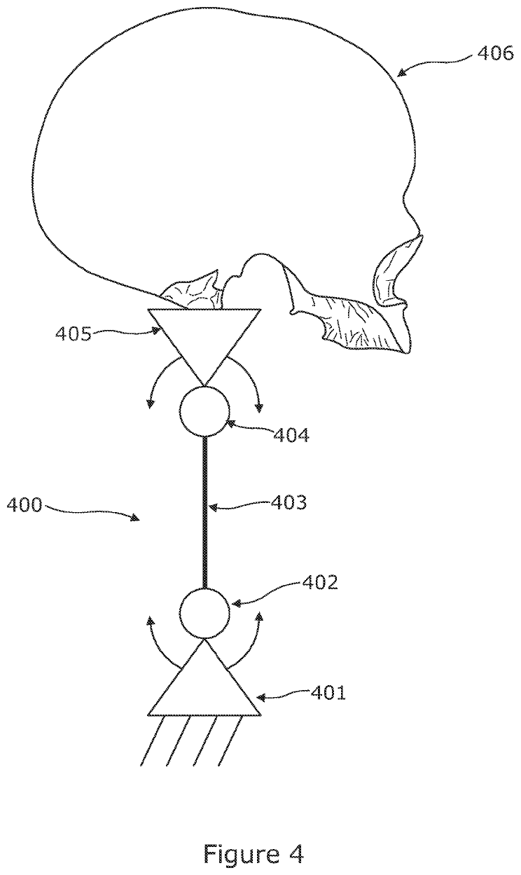

FIG. 4 is a schematic illustration of another example of a neck assembly with a surrogate head attached thereto; and

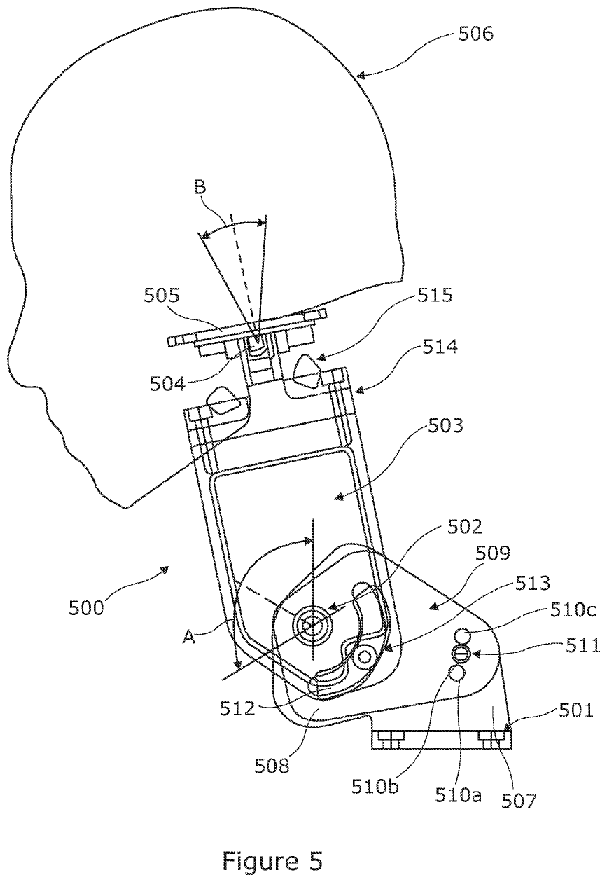

FIG. 5 shows another example of a neck assembly with a surrogate head attached thereto.

Anthropomorphic test devices (ATDs) are artificial representations of human structures typically used to investigate injurious scenarios. Whilst ATD typically refers to the whole-body structure, the term surrogate neck may be used to refer specifically to the structure which represents the human cervical spine.

The cervical spine is a weight-bearing region within the neck and is the most mobile region of the human spine. The primary functions of the cervical spine are to provide mobility to the head, and protection to the spinal cord, along with the rest of the spinal column. The primary movements of the cervical spine are flexion, extension, lateral flexion (left and right), and axial rotation (left and right). These motions occur in the coronal plane (lateral bending), sagittal plane (flexion and extension) and transverse plane (axial rotation). The cervical spine also enables head movements resulting from a combination of these ‘primary’ motions and, therefore, displacements and rotations out of these planes.

Given any orientation of the human torso, the unsupported head/neck structures can be thought of as adopting a neutral posture with respect to the torso, which may be defined as a minimum muscle activity readiness state providing comfortable, sustainable and preferred posture.

The range of motion (ROM) of the human cervical spine is the total range of physiological intervertebral motion, as measured from the neutral posture.

The ROM of the cervical spine has two regions, known as the neutral zone (NZ) and the elastic zone (EZ). The NZ is the intervertebral motion achieved with minimal internal resistance and the EZ is the intervertebral motion produced from the end of the NZ to the end of the physiological ROM, with significant internal resistance. These phenomena may be of particular interest when considering the axial rotation ROM response of a surrogate neck.

Sports participants are exposed to a unique environment, in which traumatic brain injury (TBI) risk is elevated through deliberate and/or accidental impacts. Despite the increased awareness of the detrimental effects of TBI in sports, the causal mechanisms for different TBI types are not universally well understood. One sub-class of traumatic brain injury is so-called mild traumatic brain injury (mTBI). A concussion may constitute an example of an mTBI. There is a growing awareness of the longer-term, delayed and/or potentially lifelong detrimental effects of TBIs, including mTBIs.

Without wishing to be bound by any theory, the neck has a significant effect on head impact event outcomes. The limitations of known surrogate necks adversely influence the simulation and measurement of these outcomes. By providing an improved surrogate neck, the present disclosure may help to provide more representative and insightful data for the sports research community. In particular, by providing a surrogate neck with superior biofidelity, the present disclosure may facilitate better-informed TBI research, PPE development and PPE assessment. Hence, for example, it may be possible to reduce the number and severity of TBIs experienced by participants in sport.

FIG. 1 shows a neck assembly 1 for use in an anthropomorphic test device (ATD).

The neck assembly 1 comprises a first mount 2 disposed at a lower end. A first rigid member 8 is connected to the first mount 2 via an arm member 4. A first ball joint 14 is connected to the first rigid member 8 and a first plate 20 is fixed upon the first ball joint 14.

A second rigid member 26 is disposed upon an opposing side of the first plate 20 to which the first ball joint 14 is connected. A second plate 28 is connected to the second rigid member 26 and a second ball joint 34 is connected to an opposing side of the second plate 28 to which the second rigid member 26 is connected.

A third rigid member 38 is connected to the second ball joint 34. A plain bearing 44 is connected to the third rigid member 38 and a third plate 46 is disposed upon the plain bearing 44. A third ball joint 52 is connected to the third plate 46, and a second mount 58 is connected to an opposing side of the third ball joint 52 to which the third plate 46 is connected.

The first mount 2 is disposed near to or at the lower end of the neck assembly 1, when the neck assembly 1 is arranged as shown in FIG. 1. The first mount 2 is configured to form a connection with a base structure (not shown) such as a surrogate torso. In some embodiments, the base structure may comprise a test rig such as a testing platform. For example, the first mount 2 may be connected to the base structure, in use, by a plurality of mechanical fasteners, e.g. bolts.

The first mount 2 comprises an arm member 4 that extends away from the centre of the first mount 2. The arm member 4 comprises a substantially horizontal planar surface 6 to which the first rigid member 8 is connected. The planar surface 6 has a substantially circular perimeter.

A bottom face 10 of the first rigid member 8 is fixedly connected to the planar surface 6 of the first mount 2 by any suitable means, such as one or more bolts. The first rigid member 8 is arranged such that it may be placed in a desired orientation before being fixedly connected to the first mount 2. The first rigid member 8 comprises a wedge shape such that the bottom face 10 is disposed within a different plane from a top face 12.

The first ball joint 14 comprises a bearing 16 fixedly connected to the first rigid member 8. The first ball joint 14 comprises a socket portion 18 arranged such that it may rotate about the bearing 16 and is connected to an underside of the first plate 20. In some embodiments the bearing 16 is an integral portion of the first rigid member 8. The first ball joint 14 approximately represents movement between the C6 and T1 vertebrae within a human spine.

The first plate 20 comprises a substantially circular disc shape. An underside and an opposing top side of the first plate 20 comprise substantially planar surfaces, separated by a thickness.

Connected to the top side of the first plate 20 is the second rigid member 26. The second rigid member 26 comprises a substantially similar wedge shape to the first rigid member 8, but is rotated through approximately 180° about an axis perpendicular to the plane of the top face 12 of the first plate 20. In this way, the direction of the wedge shape of the first rigid member 8 is substantially opposite the direction of the wedge shape of the second rigid member 26.

The second plate 28 is connected to a top surface of the second rigid member 26, and comprises a substantially similar disc shape to the first plate 20. Similarly to the first plate 20, the underside and an opposing top side of the second plate 28 comprise substantially planar surfaces, separated by a thickness.

Connected to the top side of the second plate 28 is the second ball joint 34. The second ball joint 34 comprises a lower socket portion 36 fixedly connected to the top side of the second plate 28, and a bearing 35 rotatably connected to the lower socket portion 36. The second ball joint 34 is positioned and arranged to simulate the movement between the C3 and C5 vertebrae within a human cervical spine.

A lower side of the third rigid member 38 is connected to the bearing 35 of the second ball joint 34 and comprises an upper socket portion 40. An upper side of the third rigid member 38 comprises a substantially planar surface upon which the plain bearing 44 is disposed. The plain bearing 44 comprises a substantially circular shape with a similar diameter to the third plate 46.

The plain bearing 44 comprises a planar surface on a lower side, which contacts the planar surface of the third rigid member 38. The planar surfaces are slidable relative to each other. The planar surfaces in contact with each other are low-friction surfaces. A fastener such as a bolt is used to connect the plain bearing 44 to the third rigid member 38. The fastener extends through a substantially central aperture in the plain bearing 44 and extends into the third rigid member 38. The fastener is configured to provide a low friction connection with the plain bearing 44, such that the plain bearing 44 rotates freely.

The plain bearing 44 comprises two projections (not shown), spaced apart from one another, extending from a lower surface thereof. The third rigid member 38 comprises two corresponding channels (not shown), each channel extending along an arc between a first end and a second end. Each channel comprises a depth at least equal to the height of the corresponding projection. Each projection extending from the lower surface of the plain bearing 44 is configured to be received by a channel disposed within the third rigid member 38. The plain bearing 44 is able to rotate, in use, between two end points, the end points being determined by the projections reaching an end of the channel in which they are received. The plain bearing 44 may rotate with little or negligible frictional resistance between the two end points. Upon the projections reaching an end of their respective channels, the projections will abut a side wall of said channel and therefore the plain bearing 44 will be prevented from rotating further. The rotation provided by the plain bearing may approximate the axial rotation achieved between the C1 and C2 vertebrae of the human cervical spine. The plain bearing 44 is configured to rotate with a relatively small resistance to rotation. Accordingly, the plain bearing 44 provides a representation of neutral zone axial rotation.

The third plate 46 comprises a substantially similar disc shape to the first 20 and second plate 28. Similarly to the first 20 and second plates 28, the underside and an opposing top side of the third plate 46 comprise substantially planar surfaces, separated by a thickness.

The third ball joint 52 comprises a socket portion 54 and a bearing 56. The socket portion 54 of the third ball joint 52 is connected to a top side of the third plate 46 and the bearing 56 is received by the socket portion 54.

The bearing 56 of the third ball joint 52 comprises an integral portion of the second mount 58. In some embodiments, the bearing 56 may comprise a discrete component and may be connected or joined to the second mount 58.

The second mount 58 comprises a mounting platform 60 on an opposing surface to the bearing 56 of the third ball joint 52.

The mounting platform 60 of the second mount 58 comprises an adjustable connection means (not shown) adapted to be connected, in use, to a test structure such as a surrogate head. The mounting platform 60 is adjustable so that it can be connected, in use, to a plurality of different surrogate heads. In some embodiments, the mounting platform 60 and/or the connection means may be adjustable in an X- and/or a Y-direction such that the line of gravity of a connected surrogate head can be moved in relation to the first mount.

The first rigid member 8 comprises four spaced-apart attachment members 62. Each attachment member 62 extends across a cut-out region (not shown) disposed near the top surface 12 of the first rigid member 8. The attachment members 62 each comprise an elongate cylindrical shape.

The second mount 58 comprises four spaced-apart attachment members 64. Each attachment member 64 extends across a cut-out region (not shown) extending through a portion of the mounting platform 60. The attachment members 64 each comprise an elongate cylindrical shape.

The first plate 20 comprises four spaced-apart attachment members 66. The first plate 20 comprises four cut-out regions spaced apart and located near the perimeter. Each cut-out region extends through the full thickness of the first plate 20. The attachment members 66 are arranged such that one attachment member 66 spans across each of the cut-out regions. The attachment members 66 each comprise an elongate cylindrical member.

The third plate 46 comprises four spaced-apart attachment members 68. The third plate 46 comprises four cut-out regions spaced apart and located near the perimeter. Each cut-out region extends through the full thickness of the third plate 46. The attachment members 68 are arranged such that one attachment member 68 spans across each of the cut-out regions. The attachment members 68 each comprise an elongate cylindrical member.

An elastic member 70 extends from each of the attachment members 62 of the first rigid member 8 to a corresponding attachment member 66 of the first plate 20 such that the elastic members 70 span across the first ball joint 14.

An elastic member 72 extends from each of the attachment members 64 of the second mount 58 to a corresponding attachment member 68 of the third plate 46 such that the elastic members 72 span across the third ball joint 52.

The second rigid member 26 comprises a first pair of buckles 76. The first pair of buckles 76 are disposed upon opposing sides of the second rigid member 26. The third rigid member 38 comprises a second pair of buckles 78. The second pair of buckles 78 are disposed upon opposing sides of the third rigid member 38. The buckles 76, 78 are arranged on the lateral sides of the neck assembly 1.

The buckles 76 connected to the second rigid member 26 comprise an attachment means 80. The buckles 78 connected to the third rigid member 38 comprise an attachment means 82.

An elastic member 84 is connected to and arranged to extend between a buckle 76 connected to the second rigid member 26 and a buckle 78 connected to the third rigid member 38 on one lateral side of the neck assembly 1. Another elastic member 84 is connected to and arranged to extend between a buckle 76 connected to the second rigid member 26 and a buckle 78 connected to the third rigid member 38 on the opposing lateral side of the neck assembly 1. The elastic members 84 extending between the buckles 76, 78 are arranged such that they span across the second ball joint 34.

The buckles 76 are rotatably connected to the second rigid member 26 and the buckles 78 are rotatably connected to the third rigid member 38 by rotatable connecting means 86. The rotatable connecting means 86 are arranged such that the buckles 76, 78 may rotate freely about their respective connections with the second rigid member 26 and the third rigid member 38.

The second plate 28 comprises two spaced-apart attachment members 74. A first attachment member 74 is disposed towards the front, and a second attachment 74 member is disposed towards the back, of the neck assembly 1. The attachment members 74 are arranged such that one attachment member 74 spans across each of two cut-out regions. The attachment members 74 each comprise an elongate cylindrical member.

An elastic member 88 is arranged to extend between and form a connection with the first attachment member of the second plate 28 and the third rigid member 38, towards the front of the neck assembly 1. An elastic member 90 is arranged to extend between and form a connection with the second attachment member of the second plate 28 and the third rigid member 38, towards the back of the neck assembly 1. The elastic members 88, 90 are arranged such that they span across the second ball joint 34.

Each elastic member 70, 72, 84 comprises a polymer such as a rubber. The elastic members 70, 72, 84 are arranged such that the first ball joint 14, the second ball joint 34 and the third ball joint 52 are resiliently biased towards a configuration representative of a standard anatomical position, as shown in FIGS. 1 and 2.

In use, the neck assembly 1 may be arranged as shown in FIG. 2. The first mount 2 may be connected to a mounting structure and a surrogate head may be connected to the mounting platform 60 of the second mount 58.

The neck assembly 1 may be arranged in any suitable orientation or configuration that is required for the relevant testing scenario. The neck assembly 1 may be arranged such that it is representative of a standard anatomical position.

In use, a plurality of testing scenarios may be carried out using the neck assembly 1, e.g. as part of an ATD. Following a first test, one or more of the elastic members 70, 72, 84 may be disconnected and changed for an elastic member comprising different elastic properties. For example, shorter elastic members may be connected to the left hand side of the neck assembly 1. This will provide the neck assembly with a neutral position tilted towards the left hand side. Alternatively, any number of the elastic members 70, 72, 84 may be disconnected and replaced with elastic members comprising a higher or lower spring constant, representative of a human neck with different levels of muscular strength and/or muscle activation. As such, in use, the same neck assembly 1 may quickly and easily be used for a plurality of test scenarios, wherein the neck assembly 1 is configurable to have different magnitudes of elastic resistance.

In use, the neck assembly 1 may be arranged such that the neutral position does not represent a standard anatomical position. The neck assembly 1 can be arranged such that it represents a person flexing forwards, extending backwards or laterally flexing left or right, within the ranges of motion of the surrogate neck. To do so, it can be appreciated that the lengths of the appropriate elastic members may be deliberately lengthened or shortened to produce a biased orientation about one or more of the anatomical planes. In addition, without changing the lengths of the elastic members, it is possible to represent a person looking to the left or right side. To do so, simply axially rotate the surrogate head about the plain bearing 44, such that the end range of motion of the neutral zone for axial rotation is reached.

It will be appreciated that the neck assembly 1 may allow for rotation in the three principal anatomical planes (i.e. the sagittal plane, the coronal plane and the transverse plane) and about axes between these planes. The neck assembly 1 also simulates the neutral zone and elastic zone for neck movements in any of these directions.

The arrangement of joints in the neck assembly 1 was designed to account for the natural lordosis of the cervical spine. In particular, the locations of the three ball joints 14, 34, 52 were selected based on a geometrically accurate computational model of the human cervical spine. In particular, the height and spacing of each cervical vertebra were aligned using Harrison's Elliptical Model and were then manipulated using intervertebral ROM values applied at normalised instantaneous centres of rotation to predict the end location and orientation of the head model. The location and range of motion of the three ball joints 14, 34, 52 were defined by matching the location and orientation of the surrogate head at the end ROM of the neck.

While the cervical spine contains more than three joints, it has been found that the neck assembly 1 comprising the three ball joints 14, 34, 52 at the locations selected through comparison to the computational human model, provides excellent biofidelity. Introducing more joints, while possible, typically may not improve biofidelity by an amount sufficient to warrant the commensurate increase in complexity (and cost) of the neck assembly. Nevertheless, a neck assembly according to the present disclosure may include fewer than three ball joints or more than three ball joints.

The excellent biofidelity of the neck assembly 1 was validated using test data from multiple studies. Static bending response characteristics of the neck assembly 1 were measured such that the results could be readily compared with those reported for humans (passive volunteer and cadavers), computational models and other surrogate necks (Hybrid III and Thor-M).

It was found that the other surrogate necks tested (Hybrid III and Thor-M) were significantly stiffer than the human (passive volunteer and cadavers) measurements and computational models throughout their respective range of movements. The neck assembly 1 was shown to have a much closer stiffness to both the human test data and computational models. The neck assembly 1 was also shown to be capable of representing both the neutral zone (NZ) and the elastic zone (EZ) of the ROM.

The neck assembly 1 was then used to study the effects of pitch-to-helmet baseball impacts. Projectile sports such as baseball involve a ball being pitched (thrown) to the batter at a high speed; typically, between 80 and 100 mph. Each of these pitches presents a risk to the batter of being hit by the ball (e.g. to the helmet, face or other part of the body).

To investigate the pitch-to-helmet baseball impacts, a bespoke high-speed ball cannon was used to accelerate the balls towards a helmeted surrogate head, which in turn was attached to a surrogate neck and then rigidly mounted to a bespoke head-cannon alignment fixture. Tests were carried out using embodiments of the neck assembly 1 and, by way of comparison, a Hybrid III surrogate neck.

FIG. 3 shows a surrogate head 300 secured to the neck assembly 1. A baseball batting helmet 301 is secured to the surrogate head 300.

The surrogate head 300 used was a surrogate head developed by Miyazaki et al. [3]. This surrogate head was developed for the purpose of investigating the sliding motion of the brain relative to the skull resulting from frontal and lateral automotive impacts. The size and shape of the skull and the brain were determined from multiple CT and MRI images of a 50^{th} percentile Japanese male individual (age: 25; height: 173 cm; mass: 65 kg). The surrogate head 300 comprises a transparent polycarbonate skull and mandible, brain (Sylgard 527 biosimulant), falx, tentorium and water as the cerebrospinal fluid to lubricate the sliding motion between the brain and skull, and the meninges that constrains the motion. Skull kinematics are measured using a six-degree-of-freedom sensor (DTS 6DX Pro) affixed to a removable polycarbonate nose.

Brain kinematics may be measured using two different techniques. In one technique, a marker pattern painted along the mid-sagittal plane of the brain and skull surfaces allows for identification on high-speed video images. This enables calculation of relative brain-skull displacement during the impact event. A downside of this technique is that the high-speed video cameras must have sight of the markers, which may not be feasible, for example, when studying helmeted impacts. Another technique utilises motion sensors such as six-degree-of-freedom sensors (e.g. modified DTS 6DX Pro) embedded in the left and right hemispheres of the surrogate brain. This technique may be advantageous when studying helmeted impacts. This technique involves processing of 18 channels of data.

It will be appreciated that other surrogate heads may be used with the neck assembly 1. For example, other surrogate heads may be more suitable for use in other impact studies.

Typically, for impact studies investigating potential TBIs, including mTBIs, a surrogate head comprising a surrogate skull containing a surrogate brain, the surrogate brain being able to move relative to the skull in as lifelike a way as possible may be preferred. Without wishing to be bound by any theory, it is thought that movement of the brain relative to the skull may be a significant contributing factor to the occurrence of some TBIs.

Experimental pitch-to-helmet baseball impacts were conducted in the laboratory. The surrogate head 300 was fitted with three motion sensors (modified DTS 6DX Pro six-degree-of-freedom sensors), which sampled triaxial linear acceleration and angular velocity of the skull and brain (left and right cerebrum) at 50 kHz. The surrogate head 300 wore a Rawlings Coolflo baseball batting helmet 301 and was impacted with standard Major League Baseball (MLB) baseballs at 80 mph using a projectile launching device. Three impact locations were defined on the helmet. A total of 40 impacts across 10 helmets were recorded, including two separate neck conditions. In the first condition, the surrogate head 300 was constrained by a Hybrid III surrogate neck (braced and aware state neck) and in the second condition, the head was constrained by the neck assembly 1 (unbraced and unaware state neck). Two data sets were considered (600 Hz and 2500 Hz cut-off frequencies) to investigate the influence of low and high frequency contents.

The experimental results confirmed that the neck assembly 1 provides a robust, repeatable and cost-effective alternative to the Hybrid III surrogate neck in the case of high-speed projectile sport impacts such as baseball and others of a similar nature (e.g. cricket and field hockey). Moreover, the neck assembly 1 may have appreciably better biofidelity than the Hybrid III surrogate neck. Accordingly, the experimental results obtained using the neck assembly 1 may be more useful than those obtained using the Hybrid III surrogate neck, for example in researching TBIs.

The interaction of the ball to the helmet, and the resulting helmet to head interaction, is a complex one and appears to be highly influenced by the relative orientation of the ball with the helmet and its tendency to be deflected by the curvature of the helmet. The complex interaction results in the tendency of the head to rotate and translate in and between the principal anatomical planes of motion, which in part is dictated by the constraint imposed by the attached surrogate neck. The helmet-to-head interaction was found to be sufficiently stiff that the influence of the neck constraint is observable during the linear (˜15 ms) and angular effect times (˜30 ms).

In both neck conditions the high frequency content of the signal significantly affected the magnitude of the resultant linear acceleration of the skull and the brain. Between the two neck conditions, larger differences in magnitude of this linear acceleration were apparent. It is therefore assumed that the neck constraint influences the resonant response of the head, which is excited by the high-speed short duration impact. This may be of importance, given its influence on the magnitude of peak resultant linear acceleration experienced by the head. Furthermore, this research presented initial findings of a surrogate head that contained instrumentation to monitor the brain's response to impact. The responses of these sensors were validated through FEA of the lateral impact case and the results showed good agreement with the characteristics of the skull and brain sensor readings during the experimental impacts. The initial research suggests that the magnitude of linear acceleration experienced by the brain is significantly higher than that experienced by the skull; and that the magnitude of this acceleration is significantly affected by the neck constraint.

The triaxial rotational kinematics of the head were significantly different between the Hybrid III surrogate neck and the neck assembly 1. The freedom of the neck assembly 1 to axially rotate during the impacts allowed for a more significant z-axis contribution to the resultant angular velocity, than did the Hybrid III surrogate neck (i.e. the lateral flexion angular velocity for the neck assembly 1 was generally decreased compared with that of the Hybrid III surrogate neck, with an increase in axial rotation). This may have clinical importance, given that the direction of the angular velocity acting on the head during an impact has been suggested as an important factor in the risk of TBI.

FIG. 4 shows schematically an example of a surrogate neck assembly 400. The neck assembly 400 is based on a pin-jointed single link planar mechanism with restricted range of motion. The distribution of range of motion within the human cervical spine may be approximated in a ratio of 1:2 between the upper and lower cervical spine. The surrogate neck assembly 400 is designed to provide this distribution of range of motion.

The surrogate neck assembly 400 comprises at a first end a first mount 401. The first mount 401 is adapted to be connected to a support structure (not shown), e.g. a surrogate thorax. The connection between the first mount 401 and the support structure will be a rigid connection.

A first pivot joint 402 provides pivoting motion in the sagittal plane between the first mount 401 and an elongate link member 403. A first end of the elongate link member 403 is pivotably connected to the first pivot joint 402. The first pivot joint 402 is configured to simulate a C6-C7 joint in a human cervical spine (i.e. in a lower portion of the human cervical spine).

A second end of the elongate link member 403 is pivotably connected to a second pivot joint 404. The second pivot joint 404 provides pivoting motion in the sagittal plane between the elongate link member 403 and a second mount 405. The second pivot joint 404 is configured to simulate a C0-C1 joint in a human cervical spine (i.e. in an upper portion of the human cervical spine).

The second mount 405 is connected to a surrogate head 406.

The neck assembly 400 provides a distributed range of motion in the sagittal plane. The first pivot joint 402 is configured to provide two-thirds of the distributed range of motion and the second pivot joint 404 is configured to provide one-third of the distributed range of motion.

FIG. 5 shows an example of a surrogate neck assembly 500 of the same type illustrated schematically in FIG. 4 and discussed above.

The surrogate neck assembly 500 comprises at a first end a first mount 501. The first mount 501 is adapted to be connected to a support structure (not shown), e.g. a surrogate thorax. The connection between the first mount 501 and the support structure will be a rigid connection.

A first pivot joint 502 provides pivoting motion in the sagittal plane between the first mount 501 and an elongate link member 503. A first end of the elongate link member 503 is pivotably connected to the first pivot joint 502. The first pivot joint 502 is configured to simulate a C6-C7 joint in a human cervical spine (i.e. in a lower portion of the human cervical spine).

A second end of the elongate link member 503 is pivotably connected to a second pivot joint 504. The second pivot joint 504 provides pivoting motion in the sagittal plane between the elongate link member 503 and a second mount 505. The second pivot joint 504 is configured to simulate a C0-C1 joint in a human cervical spine (i.e. in an upper portion of the human cervical spine).

The second mount 505 is connected to a surrogate head 506.

The neck assembly 500 provides a distributed range of motion in the sagittal plane. The first pivot joint 502 is configured to provide two-thirds of the distributed range of motion, as indicated by a double-headed arrow A, and the second pivot joint 504 is configured to provide one-third of the distributed range of motion, as indicated by a double-headed arrow B.

The first mount 501 comprises a first mount portion 507 and a second mount portion 508. The second mount portion 508 is adjustably fixable relative to the first mount portion 507 in three discrete orientations to represent three different initial orientations (postures), in this case 0°, +7°, −7°. In the illustrated example, the first mount portion 507 has a laterally-extending aperture therethrough. The second mount portion 508 comprises a pair of flanges 509, each flange 509 having a corresponding set of three apertures 510a, 510b, 510c therethrough, one for each of the three discrete orientations. To select the orientation of the second mount portion 508 relative to the first mount portion 507, one of the apertures 510a, 510b, 510c in each flange 509 is brought into alignment with the laterally-extending aperture in the first mount portion 507. A removable locking pin 511 extending through the selected apertures is used to fix the orientation of the second mount portion 508 relative to the first mount portion 507.

In other example implementations, the first mount portion 507 may be fixable relative to the second mount portion 508 in any number of different orientations.

The elongate link member 503 comprises a pair of opposing arcuate slots 512, each arcuate slot 512 extending in an arc about a pivot axis passing through the first pivot joint 502. A pin 513 extending from the second mount portion 508 is received in each arcuate slot 512. The arcuate slot 512 acts to limit the extent of pivotal motion provided by the first pivot joint 502.

In other example implementations, the extent of pivotal motion provided by the first pivot joint 502 may be limited by any other suitable mechanism.

The neck assembly 500 comprises a plurality of spacers 514, which can be used to adjust one or more upward-facing surfaces of the elongate link member 503 close to the second pivot joint 504. A plurality of rubber inserts 515 are arranged to protrude from the upward-facing surface(s).

The spacers 514 and the rubber inserts 515 allow a spacing between the one or more upward-facing surfaces of the elongate link member 503 and one or more downward-facing surfaces of the second mount 505 to be adjusted. The neck assembly 500 may be arranged such that, in use, the downward-facing surfaces of the second mount 505 come into contact with the rubber inserts 515, thereby limiting the maximum extent of rotation in the sagittal plane provided by the second pivot joint 504.

Additionally or alternatively, the extent of pivotal motion provided by the second pivot joint 504 may be limited using any other suitable means, e.g. means similar to those described above in relation to the first pivot joint 502.

The neck assembly 500 may be configured to provide different overall (distributed) ranges of motion in the sagittal plane. The overall range of motion in the sagittal plane is given by the sum of the maximum range of motion provided by the first pivot joint and the maximum range of motion provided by the second pivot joint. The first pivot joint 502 is configured to provide two-thirds of the overall range of motion and the second pivot joint 504 is configured to provide one-third of the overall range of motion. In three example implementations, the neck assembly 500 may be configured to provide overall (distributed) ranges of motion of 60°, 90° and 120°. In the first of these example implementations, the first pivot joint provides 40° of the overall (distributed) range of motion and the second pivot joint provides 20° of the overall (distributed) range of motion. In the second of these example implementations, the first pivot joint provides 60° of the overall (distributed) range of motion and the second pivot joint provides 30° of the overall (distributed) range of motion. In the third of these example implementations, the first pivot joint provides 80° of the overall (distributed) range of motion and the second pivot joint provides 40° of the overall (distributed) range of motion.

The neck assembly 500 was used in an experimental study of impacts in judo, specifically impacts from a backwards fall. In the experimental study, the neck assembly 500 was compared with the Hybrid III surrogate neck.

The surrogate head 506 used was a surrogate head developed by Miyazaki et al. [3], as described above in relation to the surrogate head 300.

Brain kinematics were measured using a technique, in which a marker pattern painted along the mid-sagittal plane of the brain and skull surfaces allows for identification on high-speed video images. This enables calculation of relative brain-skull displacement during the impact event.

The first mount 501 was rigidly connected to a judo surrogate torso.

The experimental study was conducted on an International Judo Federation (IJF) approved tatami judo mat, which was placed on top of a rubber base mat to limit slippage during the motion. A shoulder region of the judo surrogate torso was raised to 70° from the horizontal to achieve an impact velocity of 3.5 ms⁻¹, matching kinematic data of actual judo participants performing the backwards fall when thrown by the Osoti-gari technique. High speed video cameras were used to record the trials. Footage recorded by the high speed video cameras was transmitted to a data logger.

Data logged on the data logger was processed and analysed using a data processor, which in this case was a desktop computer. The marker pattern painted along the mid-sagittal plane of the brain and skull surfaces can be identified and tracked in the footage recorded by the high speed video cameras.

Skull kinematic data from the six-degree-of-freedom sensor (DTS 6DX Pro) affixed to the removable polycarbonate nose of the surrogate head 506 were also transferred to the data processor for processing and analysis.

A total of 60 trials were recorded for the study. Five repeat drops were carried out for each of the three initial neck positions (+7°, 0° and −7°) and three overall ranges of motion (60°, 90°, 120°) provided by example embodiments of the neck assembly 500. The Hybrid III surrogate neck was tested in the equivalent three initial positions with five repeats.

The results of the experimental study confirm that the neck assembly 500 represents a low-cost, highly-repeatable alternative to the Hybrid III surrogate neck. Moreover, use of the neck assembly 500 reveals findings that would otherwise be masked by the overly-stiff nature of the Hybrid III surrogate neck.

Specifically, the tested judo break fall impact scenario highlights the potential to underestimate angular kinematics of an unbraced surrogate head when the sagittal plane is overly constrained by a stiff surrogate neck (e.g. the Hybrid III surrogate neck). This underestimation may be significant when investigating traumatic brain injuries such as acute subdural hematomas (ASDH), whose prediction appears to be highly correlated to angular kinematics. The comparison between the outcomes of the Hybrid III surrogate neck and the neck assembly 500 may perhaps be similar to the comparison between skilled (braced) break fall participants and unskilled (unbraced) beginners. The latter gives rise to higher risk of bridging vein rupture and might explain the increased injury rate observed in novice judo participants in Japan.

While the example embodiments have been described in relation to sports injury research relating to TBIs, the teaching of the present disclosure may be applied in other areas. In particular, by providing a passive unbraced surrogate neck with excellent biofidelity, a neck assembly disclosed herein may be useful in many applications, including for example crash impact testing of vehicles such as cars or lorries. Another possible area of application may be in the investigation of the effects or repeated minor impacts, e.g. as might be experienced by sports participants, vehicle drivers or roller coaster riders, that over time may cumulatively contribute to delayed and/or longer term brain injuries.

By way of an example, it is envisaged that a neck assembly 1, optionally tuned with the addition of musculature structures (to represent braced or percentage braced response) could be used in a lateral sled test to investigate the risk of potential traumatic brain injuries of vehicle occupants. The ability of the neck assembly 1 to axially rotate and laterally flex could help in the understanding of traumatic brain injuries in this scenario.

Without wishing to be bound by any theory, the neck has a significant effect on head impact event outcomes. The limitations of known surrogate necks adversely influence the simulation and measurement of these outcomes. By providing an improved surrogate neck with superior biofidelity, the present disclosure may help to provide more representative and insightful data that may facilitate, for example, better-informed TBI research, PPE development and PPE assessment. Hence, for example, it may be possible to reduce the number and severity of TBIs experienced by participants in sporting and/or non-sporting activities.

While the invention has been described with reference to certain example embodiments, various modifications will be apparent to a person skilled in the art without departing from the scope of the invention.

### REFERENCES

[1] FOSTER, F. J., KORTGE, J. O. and WOLANIN, M. J. “Hybrid III—A Biomechanically-Based Crash Test Dummy.” SAE Transactions 86 (1977): 3268-283

[2] LUCK, J. L., CUTCLIFFE, H. C., KAIT, J. R., COX, C. A., NIGHTINGALE, R. W. and BASS, C., 2014. ‘Characterization of the THOR Metric Neck in Tension-Bending, Anterior-Posterior Bending, Lateral Bending, and Torsion; Development of Injury Risk Curves and Critical Values for Injury Assessment’ October 2014, Revised November 2014 Report Prepared for NHTSA.)

[3] MIYAZAKI, Y., RAILKAR, A., AWAMORI, S., KOKEGUCHI, A., AMAMORI, I., KATAGIRI, M. and YOSHII, K., 2017. Intracranial Brain Motion Measurement in Frontal Sled Tests by using a New Anthropometric Test Dummy Head capable of Direct Brain Motion Evaluation and Visualisation. Proceedings of IRCOBI conference. IRC-17-45, 2017

1. A neck assembly for use in an anthropomorphic test device comprising:
a first mount disposed at a first end of the neck assembly, the first mount being adapted to be connected to a support structure;
a second mount disposed at -a second end of the neck assembly, the second mount being adapted to be connected to a test structure such as a surrogate head; and
at least one movable joint disposed between the first mount and the second mount, the at least one movable joint being operable to rotate about at least three axes.

2. The neck assembly according to claim 1, wherein one or more of the movable joints comprise a ball joint.

3. The neck assembly according to claim 1, wherein each movable joint comprises the same range of motion as, or a different range of motion from, any other movable joint.

4. The neck assembly according to claim 1 comprising three movable joints, the three movable joints being spaced apart and arranged to approximately simulate the C0/C1, C3/C4 and C7/T1 vertebral levels within a human cervical neck.

5. The neck assembly according to claim 1 comprising at least one resilient member arranged to extend across at least a portion of the at least one movable joint.

6. The neck assembly according to claim 1 comprising at least one pair of resilient members arranged on opposing sides of at least one of the movable joints.

7. The neck assembly according to claim 1 comprising a rotary joint disposed at a location between the first end and the second end of the neck assembly, the rotary joint being arranged to provide axial rotation about a single axis of rotation within the neck assembly, the single axis of rotation extending in a locally lengthwise direction.

8. A neck assembly for use in an anthropomorphic test device comprising:
a first mount disposed at a first end of the neck assembly, the first mount being adapted to be connected to a support structure;
a second mount disposed at a second end of the neck assembly, the second mount being adapted to be connected to a test structure such as a surrogate head;
a rigid elongate member extending between the first mount and the second mount, wherein a first end of the rigid elongate member is connected to the first mount by a first pivot joint and a second end of the rigid elongate member is connected to the second mount by a second pivot joint;
wherein the first pivot joint is configured to allow pivotal motion of the rigid elongate member relative to the first mount and the second pivot joint is configured to allow pivotal motion of the rigid elongate member relative to the second mount within a single plane of rotation about two discrete axes of rotation.

9. The neck assembly according to claim 8, wherein the first pivot joint and/or the second pivot joint is/are configured to allow relatively unrestricted rotation about their respective axes of rotation.

10. The neck assembly according to claim 8, wherein the neck assembly comprises one or more stop means to limit rotation allowed by the first pivot joint and/or the second pivot joint.

11. The neck assembly according to claim 8, wherein the neck assembly is configured to provide an overall range of motion in the plane of rotation, wherein the overall range of motion is distributed across the first pivot joint and the second pivot joint such that the overall range of motion equals the sum of the maximum rotational movements allowed by the first and second pivot joints.

12. The neck assembly according to claim 11, wherein the neck assembly is configured such that the maximum range of rotational movement allowed by the first joint is greater than the maximum range of rotational movement allowed by the second joint.

13. A neck assembly for use in an anthropomorphic test device comprising:
a first mount disposed at a first end of the neck assembly, the first mount being adapted to be connected to a support structure;
a second mount disposed at a second end of the neck assembly, the second mount being adapted to be connected to a test structure such as a surrogate head; and
a rotary joint disposed at a location between the first end and the second end of the neck assembly, the rotary joint being arranged to provide axial rotation about a single axis of rotation within the neck assembly, the single axis of rotation extending in a locally lengthwise direction.

14. The neck assembly according to claim 13, wherein the rotary joint is disposed between the first mount and the second mount.

15. The neck assembly according to claim 13, wherein the rotary joint comprises a plain bearing.

16. The neck assembly according to claim 7, wherein the rotary joint is positioned and arranged to provide a realistic neutral zone for axial rotation at the C1-C2 joint region of the human cervical spine

17. The neck assembly according to claim 1, wherein the second mount is adjustable to form, in use, a connection with one or more different test structures.

18. The neck assembly according to claim 1, wherein the first mount comprises a first mount portion and a second mount portion, wherein the second mount portion is adjustably fixable relative to the first mount portion in a plurality of orientations, to represent, in use, different initial orientations (postures).

19. An assembly comprising:
a neck assembly according to claim 1; and
a test structure connected to the second mount.

20. The assembly according to claim 19, wherein the test structure comprises a surrogate head.

21-24. (canceled)
